(19) United States
(12) Patent Application Publication
(10) Pub. No.: US 2008/0229335 A1
(43) Pub. Date: Sep. 18, 2008

(54) NETWORK MEDIA DEVICE

(75) Inventors: JEFFREY L. ROBBIN, LOS ALTOS, CA (US); DAVID HELLER, LOS ALTOS, CA (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: APPLE COMPUTER, INC., CUPERTINO, CA (US)

(21) Appl. No.: 11/530,855

(22) Filed: Sep. 11, 2006

Related U.S. Application Data
(63) Continuation-in-part of application No. 10/862,115, filed on Jun. 4, 2004.
Application No. 10/862,115 is a continuation-in-part of application No. 11/306,557, filed on Jan. 2, 2006.

(51) Int. Cl. G06F 9/44

(52) U.S. Cl. 719/328

(57) ABSTRACT

A network media device is described that pulls multimedia data from one or more sources (e.g., a multimedia website or a multimedia server computer) at a first time, stores it to long-term storage within the device and transmits the stored multimedia data to one or more designated multimedia playback devices at a second time.

### CROSS-REFERENCE TO RELATED APPLICATIONS

This application claims priority to U.S. patent applications entitled “Networked Media Station,” filed 4 Jun. 2004 (Ser. No. 10/862,115) and “System and Method for Synchronizing Media Presentation at Multiple Recipients,” filed 2 Jan. 2006 (Ser. No. 11/306,557), both of which are hereby incorporated by reference.

This application is also related to U.S. patent application entitled “Transfer and Synchronization of Media Data”, filed of even date herewith, (Ser. No. ______), attorney docket number APL1P522/P4582US1, which is hereby incorporated by reference.

### BACKGROUND

With the increasing capacity and capability of personal computers, as well as improved multimedia interfaces for these computers, it has become popular to use personal computers as a repository for multimedia content, such as songs, movies, etc. Particularly with music, the increased popularity of storing multimedia information on a personal computer has resulted in a variety of products and services to serve this industry. For example, a variety of portable players of encoded multimedia information have been developed, including, for example, the iPod® produced by Apple Computer. Additionally, services have been developed around these devices, which allow consumers to purchase music and other multimedia information in digital form suitable for storage and playback using personal computers, including, for example, the iTunes® music service, also run by Apple Computer. (IPOD and ITUNES are registered trademarks of Apple Computer, Inc.)

Services such as iTunes and the substantially unlimited storage space provided by modern personal computer systems has resulted in an environment where many consumers use their personal computer as their primary vehicle for obtaining, storing, and accessing multimedia information. Because consumers may access their multimedia content at virtually any time of the day, however, this implies that one's personal computer system must be powered and operational at all times. Additionally, consumers may prefer to experience certain media content, particularly video content such as movies, using more entertainment-oriented devices, such as home theater systems, which typically include larger screens and higher fidelity audio systems than personal computer systems.

Thus, it would be beneficial to provide a mechanism whereby a consumer could off-load, over a computer network, specified multimedia content to a playback device that could, at a later time, send the information to conventional entertainment devices such as stereo equipment, televisions, home theatre systems, etc.

### SUMMARY

A network media device is described that receives multimedia data from one or more sources (e.g., a multimedia website or a multimedia server computer) at a first time, stores it to long-term storage within the device and transmits the stored multimedia data to one or more designated multimedia playback devices at a second time. In some embodiments, the network media device obtains multimedia data using a pull operation. In one embodiment, the pull operation is effected through an Ethernet (wired or wireless) connection. In another embodiment the pull operation is effected through a peripheral connection (e.g., a USB or FireWire interface). Media content may also be pushed to the device using the same interfaces. In yet another embodiment, the network media device may also stream multimedia data from another source, obtained through either a pull or push operation.

### BRIEF DESCRIPTION OF THE DRAWINGS

FIG. 1 shows, in block diagram form, a multimedia system in accordance with one embodiment of the invention.

FIG. 2 shows, in block diagram form, a network media device in accordance with one embodiment of the invention.

FIGS. 3A and 3B show, in flowchart form, a multimedia data source designation operation in accordance with one embodiment of the invention.

FIGS. 4A and 4B show, in flowchart form, a multimedia playback operation in accordance with one embodiment of the invention.

FIG. 5 shows a graphical user interface used to control synchronization between a network media device and a content source in accordance with one embodiment of the invention.

Figure shows a graphical user interface used to control synchronization between a network media device and a content source in accordance with one embodiment of the invention.

### DETAILED DESCRIPTION

The following description is presented to enable any person skilled in the art to make and use the invention as claimed and is provided in the context of devices and applications compatible with computer systems manufactured by Apple Computer, Inc. of Cupertino, Calif., are illustrative only and should not be considered limiting in any respect. Accordingly, the claims appended hereto are not intended to be limited by the disclosed embodiments, but are to be accorded their widest scope consistent with the principles and features disclosed herein.

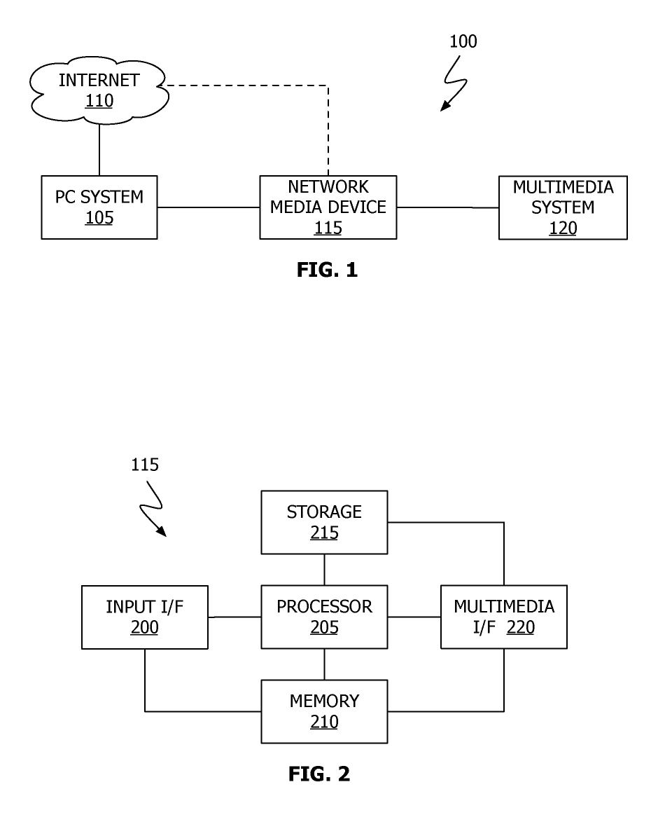

Referring to FIG. 1, illustrative multimedia system 100 is shown as comprising personal computer system 105 coupled to Internet 110 and network media device 115 which, in turn, is coupled to multimedia system 120. Network media device 115 may also be coupled to Internet 110 (see dashed line). Personal computer 105 and network media device 115 may be coupled directly to Internet 105 or indirectly through, for example, a local area network or DSL or cable modem. In general, personal computer system 105 may be any computer system capable of executing a general purpose operating system such as, for example, OS X from Apple Computer or the Windows® or Linux® operating systems. (WINDOWS is a registered trademark of Microsoft corporation. LINUX is a registered trademark of Linus Torvalds.) Multimedia system 120 may comprise any system adapted to receive and play audio (e.g., analog and digital) and/or video (e.g., composite video, S-video, component video, DVI) signals.

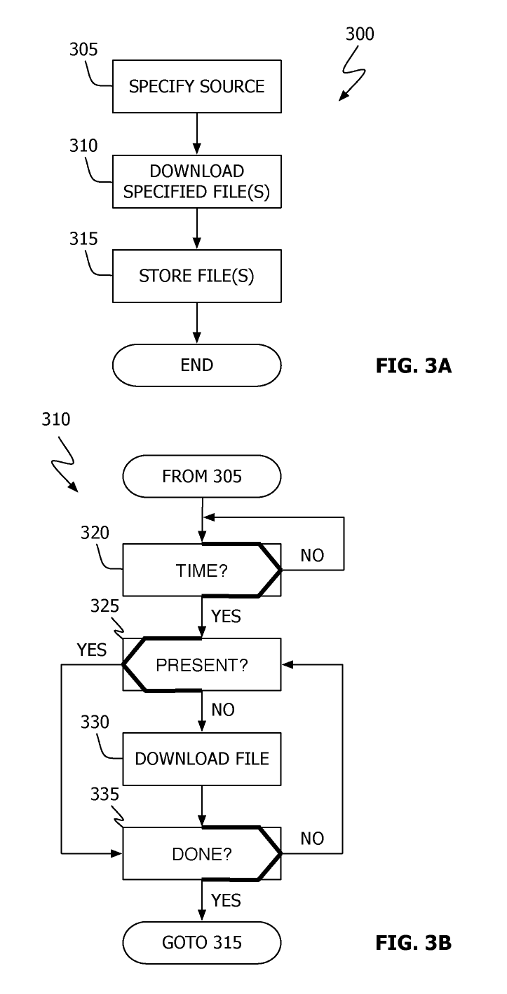

Referring to FIG. 2, network media device 115 comprises input interface 200, processor unit 205, memory 210, storage 215 and multimedia interface 220. In one embodiment, input interface 200 includes a network interface and a peripheral interface. A network interface provides wired (e.g., Ethernet) and/or wireless (e.g., I5E 802.11b or 802.11g—“WiFi”) connectivity to a computer network. A peripheral interface may include one or more connectors suitable for linking to another device such as, for example, a USB, I5E 1394 (“Firewire”), RS-232 (serial interface) or I5E 1284 (parallel interface) bus connectors. Referring to FIG. 1, for example, network media device 115 could be connected to computer system 105 through a wired network connection or by a USB bus and to Internet 110 through a wireless Ethernet connection. Processor 205 may be a single computer processor (e.g., a commercially available CICS or RISC processor), a special purpose processor (e.g., a digital signal processor, “DSP”), a plurality of interconnected processors or a custom designed state machine embodied in, for example, an application specific integrated circuit (“ASIC”) or field programmable gate array (“FPGA”). Memory 210 represents random access memory (volatile and/or non-volatile), while storage 215 represents long-term non-volatile memory such as, for example, a magnetic or optical disk unit. As noted above, multimedia interface 220 comprises connectors suitable for transmitting audio (e.g., analog and digital) and/or video (e.g., composite video, S-video, component video, DVI) signals.

As used herein, a network media device (e.g., device 115) is a physical unit having non-volatile long-term storage (e.g., storage 215) and whose operation is governed by a limited-use operating system. By limited-use, it is meant that the operating system does not support the execution of a general purpose user interface (e.g., a standard windowing environment) and, therefore, the execution of general-purpose applications (e.g., word processors and drawing programs).

As noted above, a function of device 115 is to obtain multimedia files, retain them in storage 215, and then transmit them at a later time to one or more multimedia devices (e.g., a stereo or television). To facilitate these operations, device 115 preferably includes a limited-use operating system that provides a user interface to (1) identify and select multimedia files that should be obtained and (2) identify and select which multimedia files to transmit to a designated multimedia device. In one embodiment, this interface is provided through a stand-alone application executing on a general purpose computer system (e.g., personal computer system 105) through, for example, an Ethernet connection or a USB port within input interface 200. In another embodiment, device 115 provides a web interface through a network connection (wired or wireless) within input interface 200. It will be recognized that this latter approach is often provided by other network devices such as, for example, routers and firewalls. In still another embodiment, device 115 provides a user interface through a connected multimedia playback device such as, for example, a television display. In this embodiment, device 115 could transmit the visual representation of a user interface through a video output connector within multimedia interface 220.

User interaction could be mediated through a special-purpose control device unique to device 115 or a multimedia-aware remote control unit for the display unit (e.g., television). In any of these implementations, sources of multimedia data files available through input interface 200 (i.e., network and/or peripheral connectors) may be identified. For example, multimedia files or directories located on personal computer system 105 or a server computer system coupled to system 100 via Internet 110 (not shown in FIGS. 1 and 2), may be designated as a “source.” Once identified, network multimedia device 115 may obtain or download the specified file(s) immediately. Alternatively, network multimedia device 115 may be commanded to obtain one or more multimedia files from a designated source location on a periodic basis. During periodic download operations, it is preferable that files already obtained and resident on storage 215 are not downloaded again. It will be recognized that this latter function is often referred to as “synchronization.” Once obtained, the user interface permits a multimedia data file to be transmitted to one or more designated multimedia playback devices. In one embodiment, this action may be performed immediately (that is, as soon as the user designates both a multimedia data file and at least one target multimedia device). In another embodiment, a multimedia data file may be transmitted to one or more designated multimedia devices at a specified time.

In addition to the software-based user interfaces described above, multimedia network device 115 may provide a hardware-based interface for media file playback. For example, a surface of device 115 may include a relatively small display on which the contents of storage 215 are displayed. One illustrative display of this type is presented by the iPod electronic device. In addition, conventional PLAY, PAUSE, STOP, SKIP, FORWARD, REVERSE, REPEAT, SELECT and cursor control buttons may be provided. If the aforementioned display is capable, one or more of the identified control buttons may be “soft” buttons. Through these elements, a user may select one or more multimedia files and one or more target multimedia devices on which to play the selected file(s).

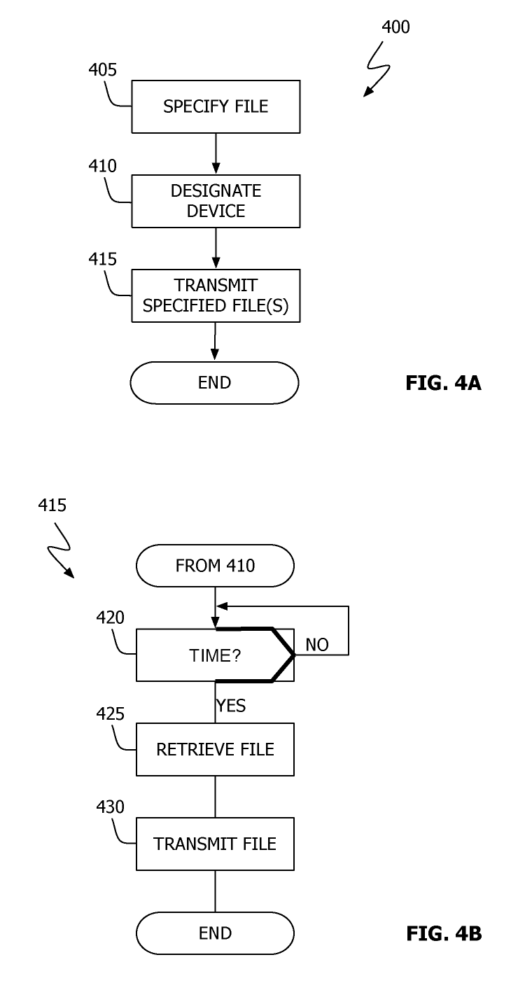

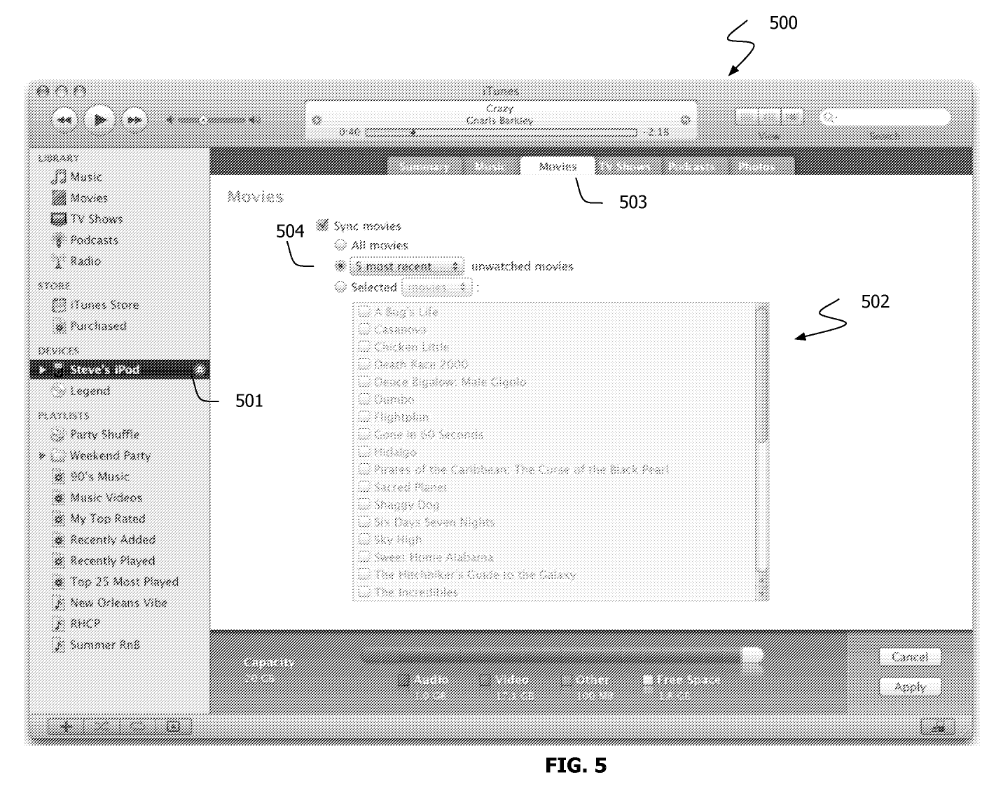

Referring to FIG. 3A, source designation process 300 for identifying one or more multimedia data files is shown. To begin, a user specifies a multimedia data source (block 305). As described above, this may include one or more files on a computer system directly coupled to multimedia device via a network or peripheral bus connector or indirectly through a computer network (e.g., the Internet or a local area network). Once designated, multimedia device 115 retrieves the specified data (block 310) and stores it internally in storage 215 (block 315). Once obtained in this manner, the multimedia data may be transmitted to one or more target devices for playback/display (see discussion below regarding FIG. 4). Additionally, by user selection, playback/display of the multimedia data may begin immediately upon designation before the transfer of the multimedia data from the source is completed.

Referring now to FIG. 3B, download operation 310 is shown in greater detail. In the illustrated embodiment, a first check is made to determine if it is the proper time to download the specified file. In one embodiment, a user may specify a time at which a download should occur. In another embodiment, the user may specify an interval after which the specified file may be downloaded. In yet another embodiment, the user may specify a repeating interval wherein one or more files may be downloaded every specified interval (e.g., day or week). It will be appreciated that this latter approach is particularly useful to periodically synchronize storage 215 with one or more other storage locations (e.g., multimedia data servers). If it is not yet time (the “No” prong of block 320), the process waits until the proper time. If it is time (the “Yes” prong of block 320), a second check is made to determine if the specified file is already present in storage 215. If the file is not present (the “No” prong of block 325), the file is downloaded from the specified location (block 330). It will be recognized that some multimedia data sources may stream the specified data to multimedia device 115. In these instances, device 115 may store the data as received (i.e., in a “streaming” format) or it may convert it to a non-streaming format. If the file is present (the “Yes” prong of block 325) or at completion of the current download operation (block 330), a third check is made to determine if all of the user-specified files have been obtained. If they have (the “Yes” prong of block 335), processing continues at block 315. if they have not (the “no” prong of block 335), processing continues at block 325.

It is noted that multimedia data files may be encoded in accordance with any one of a number of different formats. For example, MPEG-1 (Moving Pictures Experts Group), MPEG-2, MPEG-4, MP3® (Motion Picture Expert's Group Layer 3), A3 (Advanced Audio Coding, a/k/a/ MPEG-4 audio), Quicktime®, AVI (Audio Video Interleave), RI6 (Resource Interchange File Format), WMA (Windows Media Audio), Ogg, etc. (MP3 is a registered trademark of Thomson Multimedia. QUICKTIME is a registered trademark of Apple computer.) The claimed invention may be used to obtain, store and transmit (to a multimedia playback device) data files using any of these, or other, data formats. It will be recognized by one of ordinary skill in the art that multimedia device 115 will incorporate decoder capability for each file format it is configured to process (e.g., software routines).

Referring to FIG. 4, multimedia data playback operation 400 is shown. To begin, a user specifies a multimedia data file for playback (block 405). Next, the user designates one (or more) multimedia playback units to which the specified data file should be sent (block 410). Multimedia device 115 then transmits the specified file to the designated multimedia playback unit. In one embodiment, multiple multimedia files may be selected and sent to one or more playback devices. For example, a music file may be transmitted to a stereo system in a first location while a digital video file may be transmitted to a display device in a second location—at the same time or at different times.

Referring now to FIG. 4B, transmit operation 415 is shown in greater detail. In the illustrated embodiment, a check is made to determine if it is the proper time to transmit the specified file. If it is not yet time (the “No” prong of block 420), the process waits until the proper time. If it is time (the “Yes” prong of block 420), the specified file is retrieved from storage 215 (block 425) and transmitted to the designated multimedia playback device via multimedia interface 220 (block 430). In one embodiment, if the target multimedia playback device supports it, device 115 could determine if the designated playback device is present and/or capable of playing the specified file (e.g., immediately prior to performing the acts of block 430). if the playback device is not available (e.g., not “online” or not able to play the specified file, an error message could be generated and/or other corrective actions taken.

It should be noted that in the discussion of FIGS. 3 and 4, various buffering, error checking, and other data transfer steps implicit in various forms of digital communications have been omitted. Nonetheless, these steps are preferably present and may be implemented in accordance with a variety of techniques known to those skilled in the art. In addition, for security and digital rights management purposes it may be desirable to determine whether networked media device 115 (and/or the user operating same) is authorized to receive the specified multimedia data files. This generally requires some form of authentication, and may be based on a public/private key system.

Because of the potentially rich feature set of network multimedia device 115 and because of the various mechanisms by which the device may interact with other devices, e.g., via network or peripheral interface, etc., the network multimedia device 115 device preferably includes automated discovery and configuration routines that simplify setup of the device. In one embodiment, for use in a network environment, the network media device 115 may use the Bonjour protocol, developed by Apple computer, to advertise the services it provides on a local network. This allows other devices, such as PC system 105 running Bonjour-compliant software, for example iTunes, to “discover” the network media device 115. Alternatively, the network media device 115 may “discover” services available on the network, such as the aforementioned PC system running iTunes.

Upon discovery of one or more services available on the network, a user interface provided by network multimedia device 115 may present a variety of options to the user. For example, the network multimedia device may present a list of multimedia libraries on the local network to which the network multimedia device may connect. This list of multimedia libraries may include libraries stored on different machines or may include different libraries stored on the same machine. Different libraries stored on the same machine may include libraries belonging to multiple users, e.g., iTunes libraries for multiple people, or may include different types of libraries, such as an iTunes library, an iPhoto® library, etc. (IPHOTO is a registered trademark of Apple Computer, Inc.) Within a given library, content may further be divided into different categories. For example, an iTunes library may include video content (television programs, movies, etc.) and audio content (music, audiobooks, Podcasts, etc.). The user may then select one or more of these shared libraries with which to connect and may further specify specific multimedia content (e.g., files) within the libraries that should be transferred to the device in accordance with one or more of the techniques described herein.

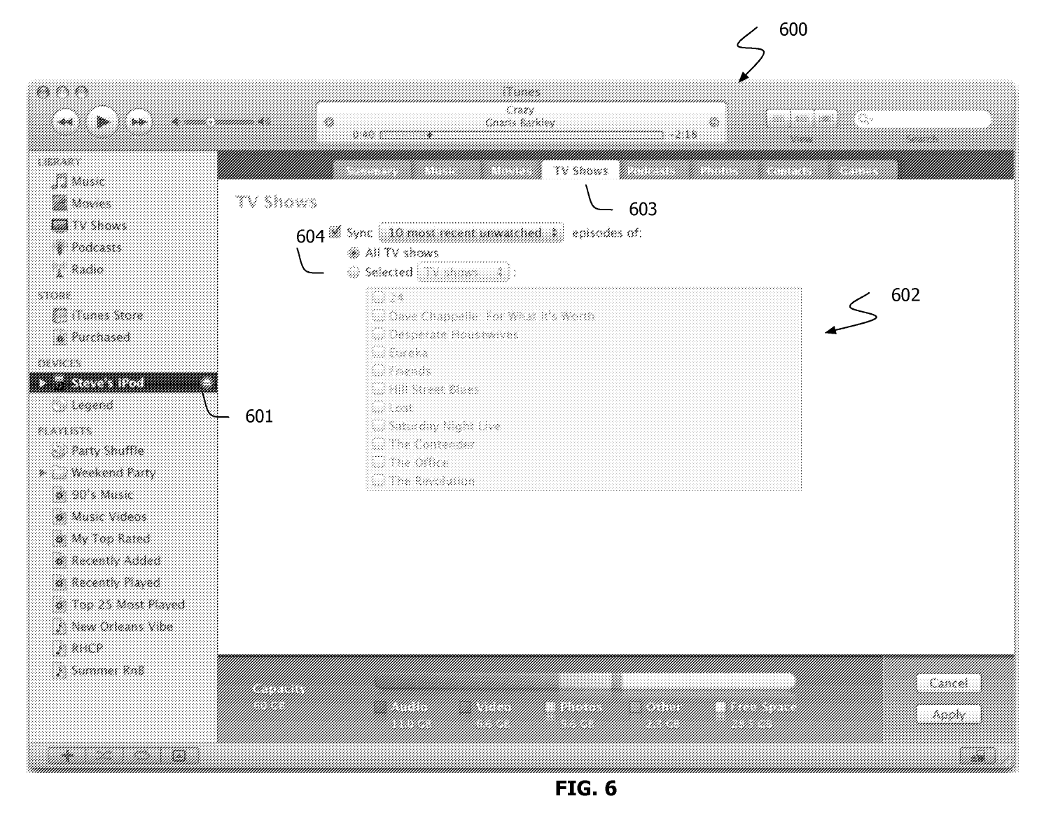

Alternatively, a user interacting with PC system 105 may also discover the services provided by network multimedia device 115. As illustrated in FIGS. 5 and 6, such a device may, for example, show up as a destination 501, 601 for multimedia content in the user interface 500, 600 of a multimedia application. The user interface provided also preferably provides the user a variety of options for which multimedia content will be transferred to the device 502, 602.

In either of the above cases, it may be desirable to “pair,” i.e., uniquely associate, a network multimedia device 115 with a particular PC system 105 or a particular library or media application thereon. Upon pairing, the network multimedia device 115 preferably ceases to advertise available services on the local network, as these services are now within the exclusive control of a particular PC system or a particular library/media application thereon. This cessation of advertising services would cause the representation 501, 601 of network multimedia device 115 to “disappear” from the user interface 500, 600 of the media applications running on other PC systems on the network. Additionally, the user interface presented by network multimedia device 115 may cease to display libraries not associated with the paired computer upon establishing a pairing.

The establishment of a pairing permits network multimedia device 115 and PC system 105 to synchronize data between them. A variety of synchronization techniques have been developed in the art and may find use in conjunction with the systems described herein. Some particularly advantageous synchronization techniques are described in U.S. Patent Publication 2003/0167318, entitled “Intelligent Synchronization of Media Player with Host Computer”; U.S. Patent Publication 2003/0079038, entitled “Intelligent Interaction Between Media Player and Host Computer”; U.S. Patent Publication 2006/0168351, entitled “Wireless Synchronization Between Media Player and Host Device”; and U.S. patent application Ser. No. ______, entitled “Remote Content Updates for Portable Media Devices”; each of which is hereby incorporated by reference in its entirety.

A wide variety of synchronization parameters may preferably be specified by the user. For example, a user may choose to synchronize certain playlists. Alternatively, a user may choose to synchronize media of a particular type (e.g., video content or audio content) or a particular sub-type (e.g., video content including television programs but not movies) 503, 603. Content to be synchronized may also be specified based on a variety of other parameters 504, 604 associated with the media content. Such parameters may include: content that has not yet been played, purchased content, locally created content, newly downloaded content, content of a certain genre, content that has not been played recently, content that is played frequently, etc. For content that comes in the form of multiple episodes, e.g., television programs, Podcasts, etc., a user may also specify how many episodes should be synchronized (for example, all episodes, unplayed episodes, or a fixed number of episodes).

The synchronization features also preferably include a mechanism for specifying content that will be automatically removed from the network multimedia device 115. For example, because of the relatively high storage requirements of storing video data, it may be desirable to remove video content from the network multimedia device once it has been viewed. Alternatively, time specific content that is sufficiently old that its value has decreased substantially, e.g., week-old news broadcasts, may be automatically removed even if they have not been viewed. Of course these concepts need not be limited to video content and may equally apply to audio content.

It may also be desirable to automatically pass changes made on one device to another without waiting for a user-initiated synchronization. Such synchronization may, for example, be event based. Thus when content is played back on the network multimedia device, its status is updated on the PC system. Similarly, if a particular media file is viewed on the PC system, it may be automatically removed from the network multimedia device. In general, it may be desirable to synchronize any change, whether adding or deleting a file, viewing a file, reclassifying a file, etc. upon the occurrence of the event without waiting for a user-initiated or time-based synchronization.

It is not necessary that the network multimedia device 115 only play back content that has been transferred via synchronization with another device, particularly one with which it is paired. For example, in addition to the synchronization techniques described herein, the network multimedia device 115 may also stream content that has not been synchronized. Such content may be either non-synchronized content located on the paired device or may be content located on a non-paired device. The user interface of network multimedia device 115 may present various indications to the user as to what content is stored locally, i.e., that which as been synchronized or otherwise transferred from another device, and that which must be streamed. Such indications may take the form of highlighting, different colors, different screen windows or panes, icons, etc. Additionally, while streaming content, it may be advantageous to transfer content faster than it is played back and cache the not yet needed content on the network multimedia device. This will, in many cases, allow the transfer to be completed long before the transfer would be completed in a classic streaming context. In this way there will be no negative effect if the device from which media is being streamed is taken off line during playback of the media.

One benefit of network multimedia device 115 in accordance with the invention is that relatively large quantities of multimedia data may be obtained via a computer network and stored an the device, whereafter they may be replayed without the need for the original source to be “on-line.” In contrast, prior art multimedia devices typically “stream” data so that the data source must be accessible during playback operations.

The network multimedia device 115 may also incorporate instant play technology as disclosed in U.S. patent application Ser. No. 11/131,800 entitled “Media Player With Instant Play Capability,” which is incorporated by reference in its entirety.

Various changes in the materials, components, circuit elements, as well as in the details of the illustrated operational methods are possible without departing from the scope of the following claims. For instance, multimedia device 115 may include a status light to provide an indication of the device's operational state. In one embodiment, a status light could be a light emitting diode (LED) or a combination of LEDs integrated into a single package to allow illumination in different colors, e.g., green, red, and/or amber/yellow. For example, the status light may be off to indicate that the device is not powered; the light may flash in a particular color, e.g., green, to indicate that it is powering up and/or going through a startup/self-diagnostic routine; the light may illuminate in a solid color, e.g., green to indicate that it is on and functioning properly; the light may also illuminate or flash in a first color, e.g., yellow, to indicate that a download is in progress and illuminate or flash in a second color, e.g., orange, to indicate a playback transmission is in progress; and the light may illuminate or flash in yet another color, e.g., red, to indicate a problem exists, such as no playback devices in range or no network signal. Further, and as well be recognized by one or ordinary skill in the art, computer program instructions for implementing the described functionality (e.g., FIGS. 3 and 4) may be organized into routines or modules and stored in memory 210 and/or storage 215.

1. A networked media device, comprising:
an input interface;
a multimedia interface; and
long-term storage,
wherein the networked media device is configured to pull multimedia data from a source coupled to the input interface, store the pulled multimedia data on the long-term storage and output the multimedia data stored on the long-term storage to a multimedia entertainment device coupled to the multimedia interface.

2. The network media device of claim 1 wherein the input interface comprises at least one wired computer network interface.

3. The network media device of claim 1 wherein the input interface comprises at least one wireless computer network interface.

4. The network media device of claim 1 wherein the input interface comprises at least peripheral interface.

5. The network media device of claim 1 wherein the multimedia interface comprises at least one audio output interface.

6. The network media device of claim 1 wherein the multimedia interface comprises at least one video output interface.

7. The network media device of claim 1 wherein the long-term storage comprises a magnetic disk storage device.

8. The network media device of claim 1 further configured to receive multimedia data from a multimedia source through at push operation.

9. The network media device of claim 1 further configured to automatically identify one or more multimedia sources available through the input interface.

10. The network media device of claim 1 further configured to automatically identify one or more multimedia output devices available through the multimedia interface.

11. The network media device of claim 1, further configured to stream multimedia data from at least one source coupled to the input interface to at least one playback device coupled to the multimedia interface.

12. The network media device of claim 1, further configured to pull multimedia data from a source coupled to the input interface at a predetermined time.

13. The network media device of claim 1, further configured to pull multimedia data from a source coupled to the input interface when a predetermined event is detected.

14. The network media device of claim 1, further configured to output the pulled multimedia data to the multimedia interface at a predetermined time.

15. The network media device of claim 1, wherein the multimedia source comprises one or more of a personal computer, a website, a digital video disk, a compact disk and a streaming media source.

16. The network media device of claim 1, further comprising a processor configured to decode the received multimedia data.

17. The network media device of claim 1, further comprising a status indicator.

18. A multimedia system comprising:
a network media device having a network interface, a multimedia interface and long-term storage; and
one or more multimedia playback devices coupled to the multimedia interface,
wherein the network media device is configured to pull multimedia data from a source coupled to the network interface at a first time, to store said pulled data to the long-term storage and to transmit said stored multimedia data to at least one multimedia playback device coupled to the multimedia interface.

19. The multimedia system of claim 18, wherein the network interface comprises an Ethernet interface.

20. The multimedia system of claim 19, wherein the Ethernet interface comprises a wired Ethernet interface.

21. The multimedia system of claim 19, wherein the network interface further comprises one or more peripheral interfaces.

22. The multimedia system of claim 18, wherein the multimedia interface comprises an audio output interface.

23. The multimedia system of claim 18, wherein the multimedia interface comprises a video output interface.

24. The multimedia system of claim 18, wherein the long-term storage comprises a magnetic disk unit.

25. A method to use multimedia data files, comprising:
identifying a multimedia data file stored on a first network device;
downloading the multimedia data file from the first network device at a first time to a second network device;
storing the downloaded multimedia file in long-term storage in the second network device;
identifying a multimedia playback device coupled to the second network device to play the downloaded multimedia file; and
transmitting the stored multimedia file to the designated multimedia playback device at a second time.

26. The method of claim 25, wherein the act of downloading comprises downloading the multimedia data file only if the multimedia data file is not already stored on the long-term storage.

27. A method of configuring a network multimedia device to receive multimedia content from at least one content source, wherein the network multimedia device and the at least one content source are coupled via at least one network, the method comprising:
discovering on the at least one network one or more services provided by the network multimedia device, wherein the one or more services provided by the network multimedia device are advertised on the at least one network using a predetermined protocol; and
accepting user input at at least one of the content sources to establish a paired relationship between the network multimedia device and the at least one content source.

28. The method of claim 27 wherein the paired relationship between the network multimedia device and the at least one content source is exclusive.

29. The method of claim 27 further comprising:
presenting at the at least one paired content source one or more multimedia libraries each containing one or more multimedia files that may be transferred to the network multimedia device;
accepting user input specifying which of the one or more multimedia files are to be transferred to the network multimedia device; and
transferring the specified one or more multimedia files to the network multimedia device.

30. The method of claim 27 further comprising:
presenting at the at least one paired content source one or more multimedia libraries that may be synchronized with the network multimedia device, each multimedia library containing one or more multimedia files;
accepting user input specifying which of the one or more multimedia libraries are to be synchronized with the network multimedia device; and
maintaining synchronization between the specified one or more multimedia libraries and the network multimedia device.

31. The method of claim 30 wherein:
accepting user input specifying which of the one or more multimedia libraries are to be synchronized with the network multimedia device further comprises specifying one or more synchronization parameters; and
maintaining synchronization between the specified one or more multimedia libraries and the network multimedia device further comprises copying one or more multimedia files to the network multimedia device and deleting one or more multimedia files from the network multimedia device according to the specified synchronization parameters.

32. The method of claim 30 wherein maintaining synchronization between the specified one or more multimedia libraries and the network multimedia device comprises automatically synchronizing in response to one or more predetermined events.

33. A method of configuring a network multimedia device to receive multimedia content from at least one content source, wherein the network multimedia device and the at least one content source are coupled via at least one network, the method comprising:
discovering on the at least one network one or more services provided by the at least one content source wherein the one or more services provided by the at least one content source are advertised on the at least one network by the at least one content source using a predetermined protocol; and
accepting user input at the network multimedia device to establish a paired relationship between the network multimedia device and the at least one content source.

34. The method of claim 33 wherein the paired relationship between the network multimedia device and the at least one content source is exclusive.

35. The method of claim 34 wherein the establishment of an exclusive paired relationship between the network multimedia device and the at least one content source causes the network multimedia device to stop advertising services provided by the network multimedia device on the at least one network.

36. The method of claim 33 further comprising:
presenting at the network multimedia device a representation of each of the at least one content sources, each of the at least one content sources having one or more multimedia libraries each containing one or more multimedia files that may be transferred to the network multimedia device;
accepting user input specifying which of the one or more multimedia files are to be transferred to the network multimedia device; and
transferring the specified one or more multimedia files to the network multimedia device.

37. The method of claim 36 wherein transferring the specified one or more multimedia files to the network multimedia device comprises streaming the multimedia files to the network multimedia device.

38. The method of claim 36 further comprising:
presenting at the network multimedia device a representation of each of the at least one content sources, each of the at least one content sources having one or more multimedia libraries that may be synchronized with the network multimedia device, each multimedia library containing one or more multimedia files;
accepting user input specifying which of the one or more multimedia libraries are to be synchronized with the network multimedia device; and
maintaining synchronization between the specified one or more multimedia libraries and the network multimedia device.

39. The method of claim 38 wherein:
accepting user input specifying which of the one or more multimedia libraries are to be synchronized with the network multimedia device further comprises specifying one or more synchronization parameters; and
maintaining synchronization between the specified one or more multimedia libraries and the network multimedia device further comprises copying one or more multimedia files to the network multimedia device and deleting one or more multimedia files from the network multimedia device according to the specified synchronization parameters.

40. The method of claim 38 wherein maintaining synchronization between the specified one or more multimedia libraries and the network multimedia device comprises automatically synchronizing in response to one or more predetermined events.
